(19) United States
(12) Patent Application Publication
(10) Pub. No.: US 2002/0112161 A1
(43) Pub. Date: Aug. 15, 2002

(54) Method and system for software authentication in a computer system

(76) Inventors: Fred C. Thomas III, Ogden, UT (US); Robert Short, Niwot, CO (US); Dave Jolley, Kaysville, UT (US); Robert Sandman, Syracuse, UT (US); Thane Heninger, West Haven, UT (US); Norman Higgs, Ogden, UT (US)

Correspondence Address: Woodcock Washburn Kurtz, Mackiewicz & Norris LLP, 46th Floor, One Liberty Place, Philadephia, PA, 19103, US

(21) Appl. No.: 09/782,501

(22) Filed: Feb. 13, 2001

(51) Int. Cl. H04L 9/32

(52) U.S. Cl. 713/176; 713/189; 709/321

(57) ABSTRACT

A data pipeline is secured in a computer system for the delivery of secure, confidential or proprietary content such as audio, video, software, copyrighted media, etc. A third party application seeks authentication information in connection with a request to deliver data to a unique medium. The system includes driver software of a host as an interface between a storage device and the third party software application, the storage device and the unique medium. The system enables authentication of the link between the third party application and the driver software by providing third party application developers a toolkit or API for interacting with the driver software. The toolkit includes means to request and decrypt an encrypted driver software digital signature previously generated based on the host's driver software and to compare the digital signature with a second digital signature generated at runtime based on the host's driver software. The third party application has access to the public key of a public/private asymmetric key pair, and the driver software is hashed and encrypted with the private key, which remains secret, to form the encrypted driver software digital signature. If a match or correlation is made based on the comparison, the link is secure and the driver software is authenticated, making way for a secure delivery of the serial number of the unique medium to the third party application.

### FIELD OF THE INVENTION

The present invention relates generally to authentication techniques in a computer system. More particularly, the present invention relates to authentication techniques in connection with the transmission of secure data from a software application to a removable storage medium. Even more particularly, the present invention relates to an authentication process occurring between first and second software elements in a computer system.

### BACKGROUND OF THE INVENTION

Music, video, books, computer software and other similar types of data packets have one characteristic in common. With modern technology, these types of content can be distributed electronically via bit streams of digital data without any requirement of physical distribution. Relative to the distribution of a physically embodied medium, digital distribution of content is easy, flexible and as a practical matter, is hard to control redistribution downstream once distributed. The single greatest challenge for digital content copyright owners and others interested in limiting the distribution of content is thus how to distribute content electronically without permitting unauthorized redistribution. MP3 music, for example, is readily available via the Internet and it can be copied and distributed to almost any client computer having a user who is willing to fly in the face of the copyright laws.

The potential loss of revenue due to piracy is not lost on the music industry and has resulted in the music industry's quest for a mechanism that permits flexible electronic distribution of content without a corresponding risk of loss due to piracy and redistribution. Thus, it would be desirable to implement an electronic data distribution mechanism that is robust enough to alleviate the concerns of content providers regarding piracy and unauthorized redistribution.

One method of controlling the unauthorized distribution of digital data is to ensure that the medium to which data is delivered is a uniquely specified medium, and to further ensure that the data may be rendered only from the uniquely specified medium, and to destroy any temporary copies made in the system after use. For example, a serial number may be assigned to a medium, and then the content provider application may request the serial number before delivery to ensure that the medium is a valid medium for delivery.

In FIG. 1A, a content providing application 10, from which music, video, books, computer software and/or other types of data may be downloaded upon valid request, communicates with a removable storage medium 70 via operating system 12, an Integrated Device Electronics (IDE) device driver 20 which drives communications with an IDE storage device 24 such as a disk drive. Thus, upon a request for content from application, or service 10, an authentication exchange occurs whereby the serial number 16 of medium 70 is communicated to the application 10, for a validity determination and incorporation into the subsequent stream of delivered data or manipulation in some other fashion. For example, the delivered data may be encrypted with the serial number 16 or a variation thereof, for subsequent operations on the data, ensuring that the data is being rendered from the authorized medium 70. Techniques utilizing the exchange of serial number 16 information may be utilized; however, these techniques have historically been vulnerable to security breaches through the emulation of one or more portions of the system. For this reason, this type of approach has not been widely accepted as a solution to the problem of unauthorized redistribution of digital data.

One reason for the existence of vulnerabilities with respect to this approach is inherent in computer systems that have several separate, but connected peripheral devices. These systems typically include various devices and/or drives that allow data to be written or read by the computer system to or from various media. For example, such devices include floppy drives, tape drives, hard drives, CD-ROMs, CD-read/writeable drives, scanners, and DVD drives among others. These devices generally communicate with a computer system through specific interface protocols, which most commonly include what are known as IDE protocols and SCSI protocols. However, ultimately a system component must rely on something in the information received as part of the communications process to determine the authenticity of the sender and as described below, this information may be mimicked under certain circumstances.

For instance, one type of vulnerability that may manifest in authentication exchanges occurring in computer systems is known as an emulator attack. An emulator is a software program and/or firmware component usually in the form of a device driver that is designed to mimic one or more pieces of hardware. For example, FIG. 1B illustrates a simple emulator attack wherein an IDE driver emulator 14 mimics an IDE device driver 20, an IDE hard drive controller 22 and an IDE drive 24. An emulator attack succeeds by tricking the application software into believing that the medium with the correct serial number is present in the drive even if there is no drive physically attached to the computer.

Since the operating system 12 believes it is communicating with an IDE device driver 20, it forwards all IOCtl (Input/Output Control) requests to the emulated drive 14 just as it would to an actual IDE Driver 20. The software application 10 has no way of verifying the authenticity of the serial number 16, and therefore this attack succeeds. For an exemplary flow of serial number information 16 from emulated removable storage 70a to software application 10, the following sequence may occur demonstrating that, in essence, the blocks below dashed line ‘a’ may be simulated or emulated.

First, the application requests serial number 16 from the (emulated) IDE drive 24 via a driver IOCtl call. Then, the emulator 14 mimics the process of reading the serial number 16 from emulated removable storage 70a, but instead reads serial number 16 from memory, from a file on the hard drive or another storage location. Emulator 14 then forwards the serial number 16 back to application 10 to emulate the completion of the IOCtl call. Application 10 then believes it has received the correct serial number 16 according to a valid exchange.

Another type of vulnerability that may manifest in authentication exchanges occurring in computer systems is known as a shim attack. The shim attack is a variation of the emulator attack. As shown in FIG. 1C, the ‘shim’ 18 is inserted between the operating system kernel 12 and the valid IDE device driver 20. The shim 18 operates to alter a key piece of information, in this case, an actual (but invalid) serial number 16a of medium 70, but forwards all other IOCtl requests from the software application 10 directly to the valid device driver 20. Thus, the shim 18 behaves as an intermediary in an ordinary communication exchange, in which the shim 18 targets only the serial number 16a or other relevant data and converts the serial number 16a into a valid serial number 16b for purposes of communicating with application 10. Because of the intransit interception and modification of particular data such as the serial number 16a, the shim attack is highly resistant to defenses based on idiosyncrasies of a storage device since aspects of the idiosyncrasies may often be mimicked.

Thus, in a typical communication of a serial number 16a from an emulated medium 70 to a software application 10, application 10 requests the serial number 16a from the IDE driver 20 via a standard IOCtl call. The shim driver 18 mimics the reading of serial number 16a from medium 70, while actually reading a serial number 16b from a file on a hard drive, or from another storage location. The shim driver 18 passes any requests other than requests made incident to the serial number 16a to and from the drive 24 via driver 20 without intervention. In the case of the serial number 16a, however, the shim driver 18 forwards the newly retrieved serial number 16b, i.e., the altered piece of relevant data, back to application 10, thereby completing the IOCtl call. Application 10 then believes it has received the correct serial number according to a valid exchange.

Other methods of reducing the risks of piracy have been proposed as well; however, these methods often compromise the privacy of the user by requiring information about the user at various levels of sensitivity. For example, while an iris scan, fingerprint, smart card, or other secure self-identifying/self-authenticating information would provide an extra assurance that a particular user is authorized to use or otherwise render a secure packet of data, such as copyrighted data, this can be an intrusive procedure that detracts from the desirability of using such a packet of data. Thus, it would be further advantageous to provide a solution to the problem of unauthorized redistribution of data that can protect the privacy of the user without severely altering the current use model.

### SUMMARY OF THE INVENTION

The present invention relates to securing a data pipeline in a computer system for the delivery of secure, confidential or proprietary content such as audio, video, software, copyrighted media, etc. A third party application seeks authentication information in connection with a request to deliver data to a unique medium. The system includes driver software of a host as an interface between a storage device and the third party software application, the storage device and the unique medium. The system enables authentication of the link between the third party application and the driver software by providing third party application developers a toolkit or API for interacting with the driver software. The toolkit includes means to request and decrypt an encrypted driver software digital signature previously generated based on the host's driver software and to compare the digital signature with a second digital signature generated at runtime based on the host's driver software. The third party application has access to the public key of a public/private asymmetric key pair, and the driver software is hashed and encrypted with the private key, which remains secret, to form the encrypted driver software digital signature. If a match or correlation is made based on the comparison, the link is secure and the driver software is authenticated, making way for a secure delivery of the serial number of the unique medium to the third party application. In addition, authentication techniques may be applied to the links between the driver software and the storage device and between the storage device and the medium, thereby securing the entire data pipeline from the third party application to the medium.

### Other features of the present invention are described below.

### BRIEF DESCRIPTION OF THE DRAWINGS

The method and apparatus for tracking information relating to objects in a system are further described with reference to the accompanying drawings in which:

FIG. 1A illustrates an exemplary circumstance under which an authentication exchange between a storage device and a content providing application may include the provision of a valid serial number from a removable storage medium of the storage device;

FIGS. 1B and 1C illustrate exemplary circumstances under which it may appear to a content providing application that a valid serial number has been received from a removable storage medium, wherein the valid serial number has been emulated;

FIG. 2A represents a prototypical computer system environment with a storage device in which the present invention may be employed;

FIG. 2B illustrates a more detailed view of a driver stack of a host system in connection with which the present invention may be implemented;

FIG. 2C represents a prototypical storage medium in connection with which the present invention might be implemented;

FIG. 3 is a block diagram depicting the various components of a typical secure data exchange between a third party application and a storage medium and the corresponding links in the exchange chain, illustrating aspects of and the desirability of the present invention;

FIG. 4 is a flow chart illustrating an exemplary process of implementing the present invention when a new or updated software driver is released in accordance with the present invention; and

FIG. 5 illustrates an exemplary authentication process between a third party application and driver software in accordance with the present invention.

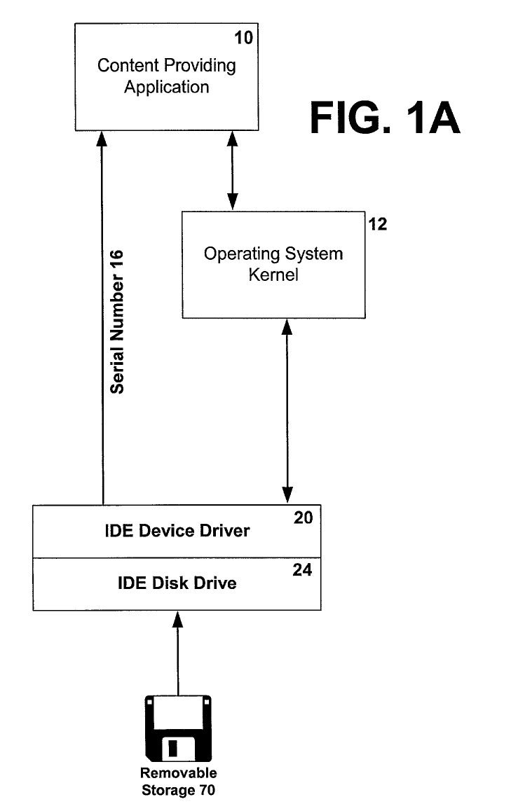

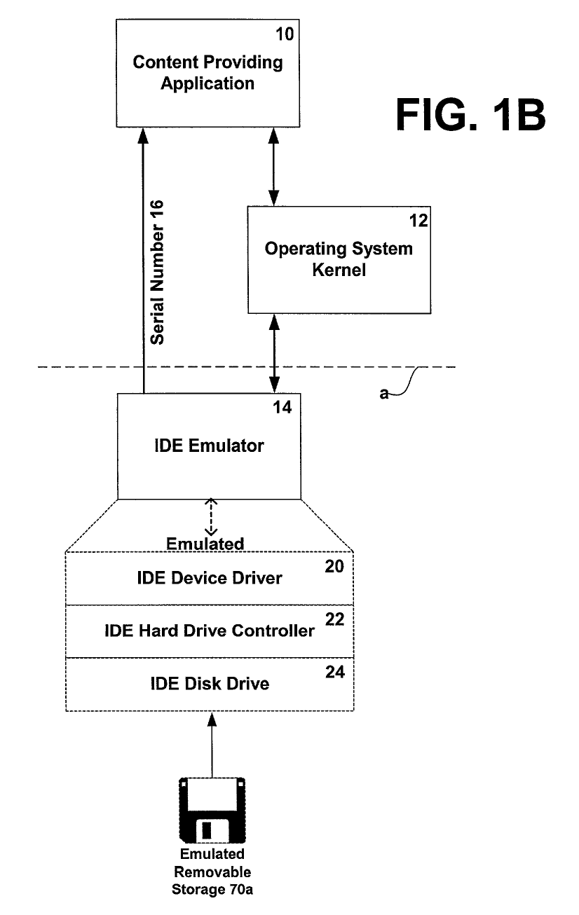

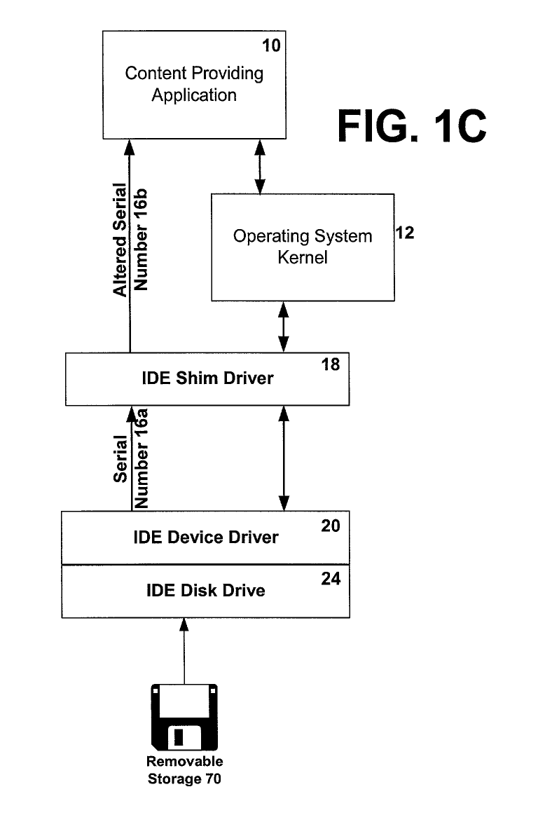

### DETAILED DESCRIPTION OF THE INVENTION

Overview

In consideration of the problems associated with the redistribution of digital content that currently exist, it is desirable to bind content to physical media in a secure fashion so that when content is purchased or otherwise distributed with authorization, it is bound via encryption to a particular medium. It may also be desirable for other data or information to be sent to a third party application from some point in the computer system. However, without a secure pipeline, this goal cannot be reliably achieved. In the case of the digital rights management example wherein a serial number is sent via an authenticated pipeline, the content can then be read, listened to, viewed, rendered or executed only if the content resides on the correct or authorized medium. Thus, content may be wrapped in a secure digital envelope, which is then written to a specified or authorized medium. The digital envelope includes the digital rights and serial number of the medium to which the content is bound. In order to use, listen to, view, execute, render, read, etc. the content, the playback device or program opens the digital envelope and compares the serial number in the digital envelope with the serial number on the medium. If there is a match or correlation is made based on the comparison, the content can be used, and permission is granted for the playback system to decrypt and play the content. Thus, this is one example showing the desirability of a secured pipeline for the transmission of a piece of information, such as a serial number of a medium, to an application.

As related in the background, the Achilles heel of such a computer system is the provision of the storage device and medium as separate components of the computer system, which can be emulated, thereby tricking the playback system into believing that the content resides on the correct media. Thus, the present invention provides an authentication technique with encryption that prevents the emulation of data considered key to authentication and rendering privileges. In this regard, the present invention provides third party applications with an application programming interface (API) toolkit including tools for interacting with specialized driver software located on a client computer, thus closing the loop and creating a fully secure data pipeline. The invention also prevents the emulation of the serial number information included on a removable storage medium. The invention thus provides an authentication technique as between two software elements in a computer system.

In operation, an exemplary embodiment of the invention performs a public domain hash function on storage device driver software to create a first driver digital signature that is then encrypted with a private key that remains secret. Then, when an application seeks to authenticate that a storage device of a target system is valid for use, the application invokes the API toolkit, whereby the same public domain hash function is performed on the driver software resident in the target system to create a second driver digital signature. At the same time, the API decrypts the first driver digital signature with a public key published or provided with the API, and determines whether the first and second driver digital signatures match or correlate. In this regard, the first and second driver digital signatures need not be identical, but rather the first and second driver digital signatures may differ by some function, shifting or transformation. If there is such a match or correlation, then the target system is valid and the serial number of the medium may be extracted and provided to the application so that a secure digital envelope may be created and downloaded to the medium with that serial number, such that only that medium may be used in connection with the use of the data in the secure digital envelope. If not, the target system is presumed insecure and the content providing application declines to deliver data to the target system.

Exemplary Computing Environment

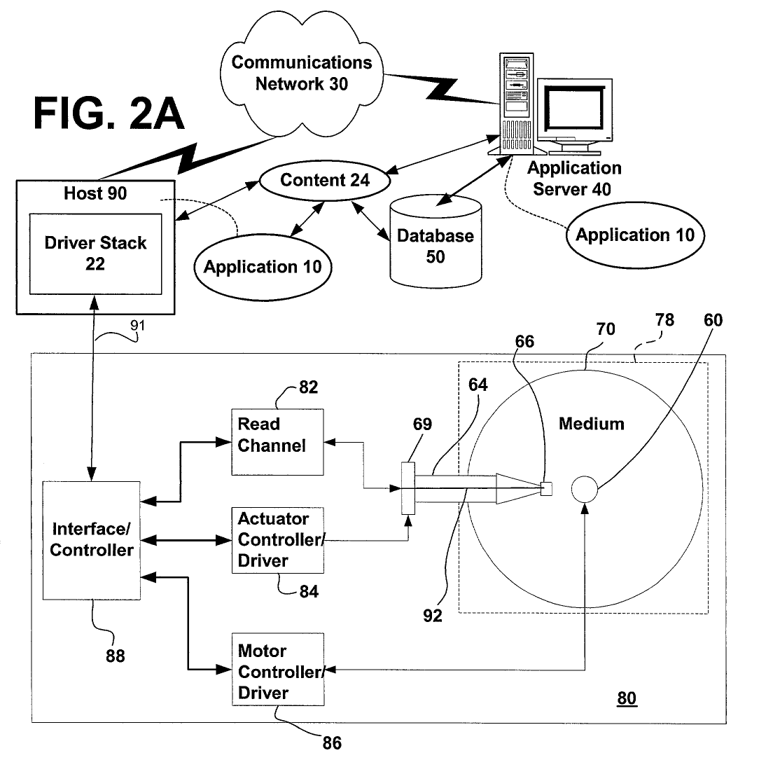

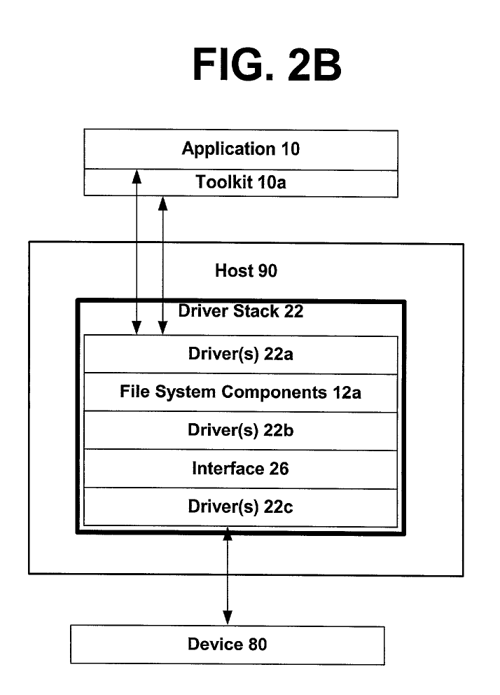

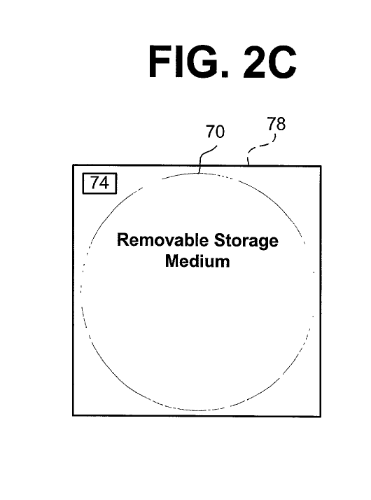

FIG. 2A is a schematic diagram of a computer system, wherein the present invention may be employed, having an exemplary data storage device 80, such as a disk drive, for storing and retrieving information for a host device 90. As such, FIG. 2A is merely one environment in which the invention may be employed. It will be appreciated that the present invention may be utilized in any computing system in which a first software element authenticates a second software element, whether the first and second software elements are co-located or communicate remotely. Host device 90 may be one of a number of various types of computer based devices such as a personal computer, a handheld computer, wireless device, video game console or the like. Host device 90 communicates with device 80 via bus 91 by sending commands to write or read digital information to or from digital recording medium 70. Bus 91 may be any one of the various buses such as parallel, generic serial, USB, fire wire, SCSI, and so on. Host 90 comprises a driver stack 22. Host 90 may communicate with a third party (remote or local) application 10, such as a content providing application, via communications network 30 connected to a server computer 40 or the memory of host 90. Server 40 may be connected to additional storage elements, such as database 50. Thus, the invention may apply to a networked computer system, wherein a remote application 10 requests authentication of a system component associated with host 90, such as driver software located in driver stack 22. In the case of a digital rights management application 10, it will be appreciated that the actual content 24 to be delivered may be stored anywhere in the system, or provided separately via a removable medium, such as a CD-ROM, etc.

In an exemplary embodiment, device 80 is a removable storage device, although driver software in driver stack 22 may control any device 80 and thus the exemplary embodiment is not intended to be limiting the types of devices that device 80 may be. Thus, in this embodiment, device 80 is a removable storage device and comprises a controller 88 that provides an interface with host device 90 and controls the overall operation of device 80. Controller 88 is preferably a microprocessor-based controller. Device 80 also comprises a read channel 82 for conditioning signals read from medium 70; actuator controller 84 for providing servo control and tracking; motor controller 86 for controlling the spin rate of medium 70 via a spindle motor 60, and an actuator assembly for reading the data from medium 70.

The actuator assembly comprises a read/write head 66 that is connected to a distal end of an actuator assembly. Read/write head 66 comprises a slider that carries a read/write element, either formed therein or attached thereto. The actuator assembly also comprises a suspension arm 64 and an actuator 69 that cooperate to move the slider 66 over the surface of medium 70 for reading and writing digital information. The read/write element of head 66 is electrically coupled to read channel 82 by way of electrical conductor 92.

As shown by FIG. 2B, driver stack 22 comprises a plurality of driver components 22a, 22b and 22c depending upon their functionality relative to file system components 12a and interface 26. Thus, while some of the description contained herein relates to the broad notion of driver software located in a host 90, it will be appreciated that multiple driver components 22a, 22b and 22c of driver stack 22 are contemplated, and that one or more driver component may be authenticated in accordance with the present invention, and that the driver components 22a, 22b, 22c, as individual software elements, may authenticate one another in accordance with the present invention as well.

Digital recording medium 70 may be one of any of the various digital data storage media such as magnetic, optical, or magneto-optical. The present invention applies to when medium 70 is removable from device 80, although the invention may be practiced in connection with the use of a bard drive having an assigned serial number or other unique identification information. As shown by FIG. 2C, when the medium 70 is removable from device 80, medium 70 may be encased in an outer shell 78 to protect medium 70 from damage. In addition to having a serial number or other uniquely identifying information, medium 70 may have portions 74 of outer shell 78 that are indentations, cavities, adhesive parts, molded parts and/or the like for receiving e.g., DIUM codes, an RF ID tag, phosphor tag, retroreflective tag, holographic marker and/or other like components that are useful as identifiers and for authentication purposes. The tag can be secured to the casing 78 or any other part or component of the recording medium 70, such as the recording layer. Also, a medium may have thereon a plurality of media indicia of the same or different types, such as RF ID tags, phosphor markers, retroreflective markers and/or the like.

Method and System for Driver Software Authentication

The present invention provides third party applications with an API toolkit including tools for closing the loop relative to a fully secure data pipeline, and for preventing the emulation of serial number information included on a removable storage medium, or other information from the computer system.

In an exemplary embodiment, when new driver software is written, the driver instruction set is hashed to create a digital signature, for example, using a public domain hash function, thereby associating a unique (first) driver signature with the driver software. Then, that digital signature is encrypted using an asymmetric cryptographic function. The private key list used to encrypt the driver signature for each driver software version is kept as a secret, whereas the public key list is published and made available to third party application developers/content providers via the API toolkit. Thus, third party digital rights management (DRM) software developers are provided with access to the list of valid public keys and the algorithm for driver authentication, which includes retrieving the encrypted first driver signature associated with the driver software e.g., from a file on the host computer provided with the driver software. For instance, an API call retrieves the encrypted first driver signature and key pair information, and as described below, the API then decrypts this signature with the corresponding public key made accessible to the third party application.

Hence, when a DRM application seeks to authenticate the driver software, the DRM application utilizes the API toolkit (a) to extract actual driver code from the driver stack 22, or portions thereof, from computer memory at run time and (b) to execute the public domain hash function on the driver code, creating a second driver signature as found on the system. Whether the relevant code is transmitted to the third party application and the hashing operation is performed by the third party application via the API, or whether the hashing is performed on the host system and then the second driver signature is transmitted to the third party application, this second driver signature becomes available to the API toolkit for further processing.

Concurrently, or in parallel, the DRM application decrypts the encrypted first driver signature as retrieved from the host system in connection with an API call. The first and second driver signatures are then compared. In the case of a successful correlation or match through the application of some comparison or function, such as whether the numbers are identical although the numbers need not be identical, the driver software is authenticated and retrieving and sending of the medium's serial number may proceed. If there is no correlation, the DRM application rejects, as unauthenticated, the storage services offered by the system driver for purposes of delivering secure data.

There has thus been an effort to determine what enabling features might be provided to allow for the secure downloading of digital data such as music, video and text. As mentioned in the background a drive-readable serial number can be provided on a storage medium. Although seemingly addressing the requirements of this market, in reality it is not presently being provided in such a manner as to ensure a robustly secure solution. The key-missing component is authentication of a secure data pipeline between the medium and a third party DRM software application.

Third party DRM software applications are responsible for managing the digital rights attributes for the content they are distributing. Such attributes include tying the contents to a unique serial number on the destination medium and managing a check-in/check-out of content to and from the system, which is also tied to the medium's serial number. For such a DRM system to be feasible, it is apparent that there is a need for a robust pipeline with authentication communications between the storage medium and third party DRM software applications.

Since the delivery of serial number information from a storage medium to the content providing application may be achieved if the data pipeline is known to be safe, the present invention provides the missing link with respect to an authenticated pipeline. The present invention, implemented in part via a software application developer's toolkit or API, is a generic solution, and can be selectively invoked by any DRM application having access to the API. As a generic solution, it may be used anytime it is desirable for a first software element to authenticate a second software element.

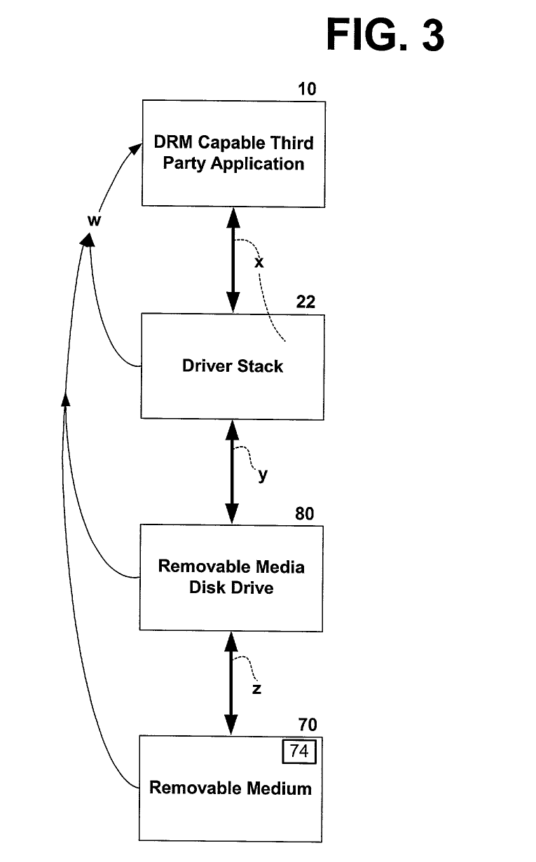

FIG. 3 illustrates an overall system architecture that reveals the various links in the data pipeline. The functional blocks of a removable data storage drive system include a DRM third party application 10, a driver stack 22, a removable media storage device 80 and a removable medium 70. Once the pipeline from the DRM third party application 10 to the driver stack 22 is authenticated, a unique medium serial number capable of authentication may be delivered from medium 70 to the DRM third party application 10 illustrated by path w for further processing. Other pieces of desirable information may be transmitted from the system as well once the system is secure.

The problem of providing a secure pipeline for the serial number of the medium 70 can be broken down into three authentication links shown as links x, y and z.

With respect to link z, the link between the storage device 80 and medium 70, a method may be provided in accordance with the present invention to authenticate that the storage device is communicating with a valid medium 70. As discussed above, a portion 74 may be placed on the medium 70 that may be used to uniquely identify the medium 70. Portion 74 serves a dual purpose, however, since portion 74 enables the storage device 80 itself to authenticate that the medium 70 is valid, and is for proper use with storage device 80. For example, any one or more of a retroreflective marker, latent illuminance marker, disk indelible utility mark (DIUM), holographic marker and the like may be utilized to provide a source for a unique serial number capable of being authenticated by storage device 80.

With respect to link y, the link between the driver stack 22 and storage device 80, a method may be provided in accordance with the present invention whereby driver stack 22 can authenticate that it truly is communicating with a valid storage device 80. In an exemplary embodiment, the present invention implements a cryptographic query and response protocol whose authentication exchange is based upon secret algorithms embedded in the storage device 80 and driver stack 22. When both the storage device 80 manufacturer and driver stack 22 developer are in cooperation, e.g., if the same company makes both, then this may be achieved with relative ease. Preferably, each authentication exchange between driver stack 22 and storage device 80 is made unique via hopping algorithms or the like, thereby thwarting potential electronic monitoring of the pipe. While this system could be implemented in the drive 80 using drive firmware, in one embodiment, the invention utilizes cryptographic authentication integrated circuits (ICs), such as those developed for the smart card industry, except tailored for use with a storage device 80. As a result, the physical security inherent with cryptographic authentication ICs, which includes a specialized manufacturing process designed to thwart analytic and instrumentation-based assaults on the device to compromise the system, may be exploited to provide a secure link y. One such use of a secure memory with authentication chip in connection with a storage device 80 is discussed in commonly assigned copending U.S. application Ser. No. 09/565,790, herein incorporated by reference in its entirety, filed May 5, 2000, entitled “Cryptographically Secured Removable Data Storage,” and claiming priority to Provisional Application Serial No. 60/176,087, filed Jan. 14, 2000. Such an implementation, however, implies the common development/manufacturing of a storage device 80 and corresponding driver software 22a, 22b and 22c in the driver stack 22, which is why this technique is not utilized for authentication between DRM third party application 10 and storage device 80. Providing half of the query and response protocol to numerous third parties is an approach that is vulnerable to compromise. Thus, driver software in the driver stack 22 may implement authentication of device 80 in accordance with the present invention.

With respect to link x, the link between the DRM third party application 10 and driver stack 22, the present invention provides a protocol by which DRM-capable third party software 10 authenticates that its communications with driver stack 22. As discussed above, the use of cryptographic query and response protocol, which is resident in two pieces of software on the computer, is vulnerable to a misappropriation of the protocol and accordingly a different approach is utilized for link x. Hence, with respect to link x, the present invention provides a method for driver software authentication by third party software application 10. This authentication may occur as between any one or more of drivers 22a, 22b or 22c located in the driver stack 22 and the application 10, and authentication may occur as between any of drivers 22a, 22b and 22c as well. A detailed description of authenticating link x is provided below.

Links x, y and z show a process of downward authentication, i.e., where third party application 10 authenticates driver stack 22, driver stack 22 authenticates storage device 80, and storage device 80 authenticates medium 70. It is also noted that the present invention may employ a two way or bi-directional authentication. For instance, this would be valuable between the device driver stack 22 and the drive 80. Thus, in another embodiment of the invention, not only can the driver stack 22 authenticate the drive 80, but the drive 80 also authenticates the driver stack 22, providing yet an additional layer of security to the process. This may be achieved by setting aside some cryptographic keys for use only by the drive 80, which are known only by the drive 80. As the driver stack 22 is developed or updated, one key link is added for link x authentication, i.e., application 10 authenticating driver stack 22, and one key link is added for reverse link y authentication, i.e., storage device 80 authenticating driver stack 22. Thus, while the driver stack 22 is authenticating the drive 80, the drive 80 could also authenticate the driver stack 22, utilizing a similar approach as proposed herein for link x. The provision of this additional link in the security chain makes the data pipeline more secure.

Similarly, this would also be valuable between the device driver stack 22 and the application 10. Thus, in yet another embodiment of the invention, not only can the application 10 authenticate drivers in the driver stack 22, but also drivers in the driver stack 22 may also authenticate the application 10, providing yet an additional layer of security to the process. The provision of this additional link in the security chain makes the data pipeline even more secure.

As yet another layer of security on the technique of the present invention, a special handshaking procedure may occur between the Application 10, or API toolkit of the invention, and the driver software in the driver stack 22. In this fashion, before the invention proceeds, the criteria of the handshaking algorithm must be met, or else any request relating to secure data is denied by the application.

There is a fourth link represented in FIG. 3 as well, in that the serial number of medium 70 should be non-alterable. Thus, the fourth link abstractly lies below the medium 70, between a potential hacker and the medium 70. While immutability of the serial number does not address authentication of the pipeline directly, it is nonetheless important if the authentication pipe is to have a deliverable, i.e., the original factory encoded unique serial number, that is trustworthy, such as for example, DIUM technology and the use of secure memory with authentication ICs. Other implementations such as RF ID tags, phosphor markers, retroreflective markers and/or the like may also be utilized alone or in combination to provide a uniquely identifiable and unalterable serial number.

Once links x, y and z are authenticated, a serial number from removable storage medium 70 may be delivered to application 10. However, as noted earlier, once the pipeline is authenticated by way of links x, y and z, any piece of relevant information may be delivered to the third party application 10 along link w. In this regard, the piece of information delivered along link w may too have a security technique associated therewith. For example, instead of providing the serial number (or other piece of information) itself too the application 10, the serial number too could be hashed and provided to the application 10 along with the serial number, hashed and encrypted with a secret private key, whereby application 10 has access to the public key via the toolkit of the present invention. In this way, a comparison of the hashed serial number to the decrypted hashed serial number would indicate the correct serial number, and provide a secure means for transmitting the serial number along link w. As an additional layer of security, this would help prevent interception of the transmission of the serial number. Typical set up and authentication processes between two software elements will now be described in accordance with an exemplary embodiment of the present invention.

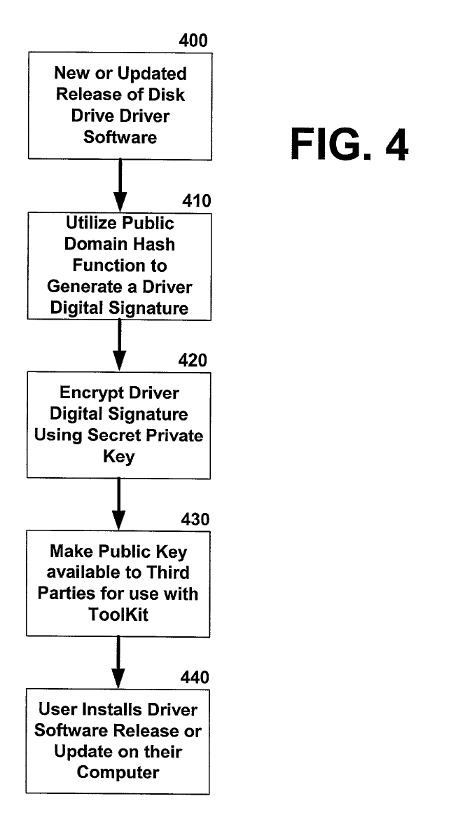

FIG. 4 illustrates an exemplary process wherein storage device driver software is processed for utilization in accordance with the present invention to secure a communications link such as link x. At start 400, a new or updated release of storage device driver software is developed. At 410, a public domain hash function is utilized to generate a driver digital signature. At 420, the driver digital signature is encrypted using a secret private key of a public/private asymmetric key pair. In one embodiment, the encrypted driver digital signature is provided with the driver software, so that the encrypted driver digital signature is available to a third party application. At 430, the public key is made available to third party applications for use with subsequent authentication exchanges via the API toolkit given to third party application developers that wish to provide content without the fears of unauthorized redistribution. In one embodiment, a public key list, having reference to a number of public keys corresponding to the number of driver versions produced in accordance with the invention, enables the API toolkit to access the appropriate public key for a subsequent decryption operation on an encrypted driver signature retrieved from the host system's driver software. Thus, when a user installs the driver software release created at 400 on a host 90 at step 440, the framework for the secure delivery of data according to the invention is in place.

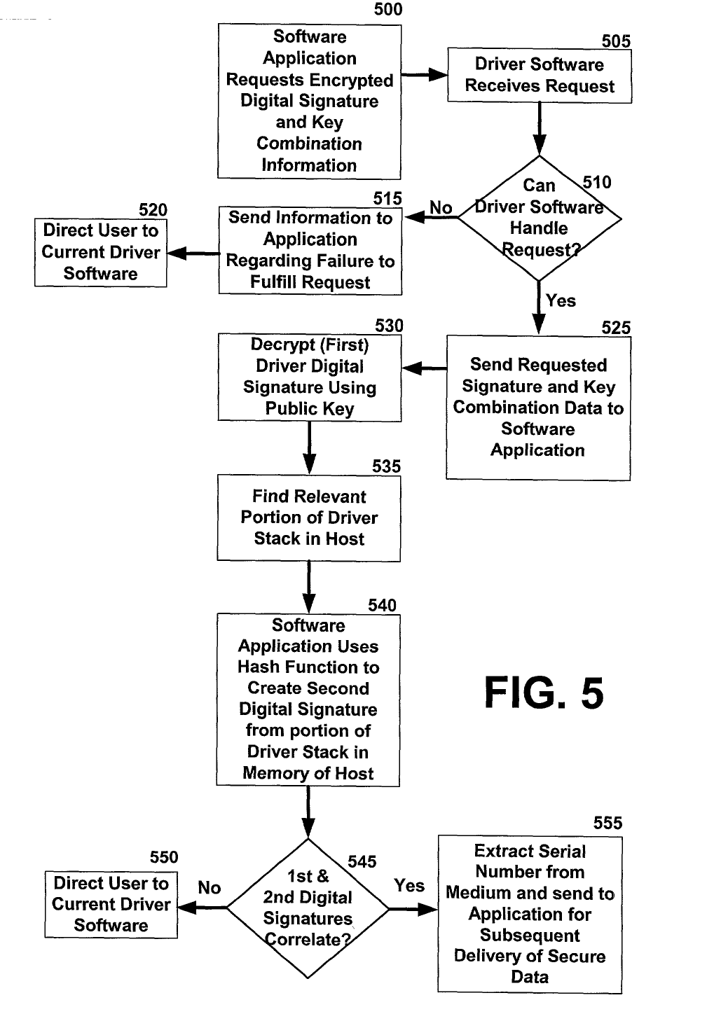

Once the computer system is set up according to the process of FIG. 4, an exemplary authentication process between a third party application 10 and driver stack 22 is performed and illustrated in FIG. 5. At 500, a software application 10 requests the encrypted digital signature and key pair information from the driver stack 22. At 505, the driver stack 22 receives the request. At 510, a determination is made as to whether the driver stack 22 is set up to handle the authentication request in accordance with the present invention. If not, then at 515, information is sent to the application 10 regarding the failure of the authentication request, and at 520, information is provided to the user how to bring their driver stack 22 into compliance with the authentication request exchange procedures of the invention. If so, then at 525, the requested encrypted digital signature and key pair information are sent to the application 10.

Then, at 530, the public key corresponding to the driver stack 22 is retrieved by the API toolkit of the application 10 and the first encrypted driver digital signature is decrypted by the application 10. At 535, application 10 accesses the relevant portion of the driver stack 22 in memory of host 90. Concurrently, serially, or in parallel, at 540, the software application 10 uses a public domain hash function, the same hash function used at 410 to create the first digital signature, to create at run-time (authentication request time) a second digital signature from at least a portion of the driver stack 22 in the memory of the host computer 90. Alternatively, the hash function may be performed by the host computer 90, and then the second digital signature may be transmitted to the application 10.

In an exemplary embodiment, access at 535 to the system's driver stack 22 is performed at run-time using an ObReferenceObjectByName function available from a commercially available DDK (Driver Development Kit) offering support for exploring object directories. For example, the ObReferenceObjectByName function can return a pointer to any object in the object directory if the name of that object is known. This means that it can be used to locate directory objects, such as storage device driver software while in kernel mode. In an alternate embodiment, the application queries through the normal communication channels for information from the device driver. The result of this query is that the device driver would share its appropriate memory space with the application, thus allowing the application to utilize and authenticate the memory footprint of the device driver. This allows this invention to be used on those systems with protected memory space. In another embodiment, where tighter restrictions are placed upon application memory space versus driver memory space, the application instantiates a proxy driver object in driver memory space, which communicates with the device driver in order to collect the information about the device driver. The proxy driver object then forwards the collected information about the device driver to the application, and the invention may then proceed as described. In yet another embodiment, the device driver becomes an integral part of the application during compilation. The application either uses this integrated device driver or installs it into the system. This allows this invention to be used on those systems with tight memory access restrictions.

At 545, the first and second digital signatures are compared by the API toolkit of the application 10 for a correlation. If there is no correlation, then at 550, the user is directed to a current version of the driver stack 22, but nonetheless insecure data may be accessed as usual. If there is a correlation, then at 555, the serial number is extracted from medium 70 and sent to the application 10 for subsequent delivery of secure data, such as copyrighted content.

In yet another embodiment, the present invention utilizes additional information with respect to the location of driver stack 22, such as path, attributes, etc. that could be used in the authentication process of FIG. 5. For example, if a standard location is set for driver stack 22 with respect to each type of operating system, this information can be maintained as consistent. As noted, to implement this approach, an environment is defined and maintained for each operating system release in relation to the driver stack 22 of the present invention.

Multiple hash functions are available for the purpose of the execution of public domain hash functions at 410 in FIG. 4 or 540 of FIG. 5. To name a few, division, multiplication, variable string addition, variable string exclusive-or, or double variable string exclusive-or hash function methods may be used. With the division method, a hash value is computed by dividing the key value by the size of the hash table and taking the remainder. With the multiplication method, a hash table size is chosen that is a power of 2. The key is multiplied by a constant, and then the necessary bits are extracted to index into the table. One method uses the fractional part of the product of the key and the golden ratio, or (sqrt(5)−1)/2. The variable string addition method, with e.g., a table size equal to 256 hashes, a variable-length string, wherein each character is added, modulo 256, to a total thereby computing a hash value in the range of 0 to 255. The variable string exclusive-or method, with e.g., a table size equal to 256 is similar to the addition method, but successfully distinguishes similar words and anagrams. To obtain a hash value in the range of 0 to 255, all bytes in the string are processed together according to the exclusive-or- function and each exclusive-or process introduces a random component. The double variable string exclusive-or method with a table size less than or equal to 65536 involves hashing the string twice, such that a hash value is derived for an arbitrary table size up to 65536. The second time the string is hashed, one is added to the first character. Then the two 8-bit hash values are concatenated together to form a 16-bit hash value.

It is noted that with symmetric or private key encryption, keys are exchanged in person to guarantee security, and thus a symmetric algorithm is only as dependable as the recipient of the key. Modern day encryption circumvents this problem through the use of asymmetric or public-private key encryption. Asymmetric key encryption is based on a type of mathematical algorithm that provides only one-way encryption/decryption i.e., the algorithm allows the encryption of a message with a special key that has some unique properties, one of which is that encrypted messages can be decrypted only with the corresponding private key. It is generally considered beyond the realm of probability to retrieve the private key through possession of the public key and encoded message of an algorithm that uses an appropriate number of bits. Thus, rather than distributing private decryption and encryption keys to trusted parties and hoping for the best, the present invention distributes a public key to any application that wishes to communicate in accordance with the invention such that messages sent to the driver software that have been encrypted with the public key are readable only by the driver software. For example, among other known algorithms, the present invention may employ RSA, Diffie-Hellman, Elliptic-Curve cryptography and/or cryptography packages, such as PGP.

It is noted that private keys also have the added benefit that a bit of text, which has been encrypted with the private key, can be verified through the use of the public key to have been encrypted by the holder of the private key. This is known as a digital signature and can be used to provide message authenticity because only the holder of the private key could encrypt such a message. The same method can be used to verify message integrity because the message sender may create a hash digest representing the pre-transmission state of the file.

Thus, at least two critical security holes are closed in accordance with the present invention: (1) upon successful authentication, the invention guarantees the authenticity of a serial number from a medium 70 to a software application 10 and (2) upon successful authentication and subsequent delivery and use of the content, the present invention guarantees the permanent deletion of content checked into the system from the medium 70, so that no residual copies remain incident to the use of the data.

In another embodiment of the present invention, when any link in the authentication chain fails for any reason, unsecured data can be read/written correctly without any problems i.e., the authentication failure is seamless to the user and unsecured data is handled as always. On the other hand, secured data, e.g., copyrighted or confidential data, is randomly lost and/or altered in the process. Thus, if someone tries to break the system, the system feedback returned to that someone during the approach may thwart the attempt. This is because when the pipeline authentication fails, there is little indication that it has failed. Portions of this can be implemented at one or more levels. For instance, secured data coming across an unsecured pipeline could be scrambled by the driver stack 22 and/or drive 80, clipped or simply thrown away. Alternatively, the DRM software application 10 could neglect to include the keys necessary to access the file in the case of authentication failure. The possibilities are endless, but in any event, the system still works even under the conditions of an authentication failure. This gives those trying to break the system a false sense of hope, whereas they may think that whatever scheme they are currently trying works or whereas they may think that whatever scheme they are currently trying partially works, without knowing which part.

The various techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a handheld device, a video recorder or the like, the machine becomes an apparatus for practicing the invention. When implemented on a general-purpose processor, the program code combines with the processor to provide a unique apparatus that operates to perform the functionality of the present invention. For example, the storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary embodiments of the invention are described in the context of a storage device and removable storage media, the invention could be practiced with any storage element suited to a secure data exchange pipeline, and having a uniquely identifiable and nonalterable characteristic. One skilled in the art will recognize that the present invention is not limited to driver software, but rather the authentication exchange procedure of the present invention could be utilized to authenticate a data exchange between any two components of a computer system. Furthermore, it should be emphasized that a variety of host computer platforms beyond the personal computer, including handheld device operating systems and other application specific operating systems are contemplated, especially as the number of wireless networked devices continues to proliferate. For example, the invention could apply to handheld computers, networked appliances, computerized ink pads, and the like. Therefore, the present invention should not be limited to any single embodiment, but rather construed in breadth and scope in accordance with the appended claims.

What is claimed is:

1. A software authentication system for authenticating a communication channel between a plurality of software elements, comprising:
a host computer having host storage including a first software element;
a second software element to authenticate said first software element;
wherein in response to said second software element making a request to said first software element for authentication of the first software element, the second software element retrieves a first encrypted digital signature from said host computer, the second software element retrieves a public key for use with said first encrypted digital signature and the second software element accesses at least one portion of a component stored in said host storage, said at least one portion of the accessed component is hashed to form a second digital signature;
wherein in response to receiving said encrypted first digital signature, said second software element decrypts said encrypted first digital signature with said public key and said second software element compares the first digital signature to the second digital signature; and
whereupon the occurrence of a correlation between said first and second digital signatures, the first software element is authenticated.

2. A software authentication system according to claim 1, wherein the first software element is a driver software element.

3. A software authentication system according to claim 2, wherein the second software element is a content providing software application, such that the content providing software application authenticates the driver software element.

4. A software authentication system according to claim 1, wherein the second software element instantiates a third software element which accesses said at least one portion of a component stored in said host storage in place of said accessing by said second software component.

5. A software authentication system according to claim 4, wherein the third software element is instantiated in memory space allocated for drivers in said host computing system, and said first software element is a driver software element.

6. A software authentication system according to claim 1, wherein the component stored in host storage is the first software element.

7. A software authentication system according to claim 6, wherein the access of the first software element stored in host storage is during runtime of the software authentication system.

8. A software authentication system according to claim 1, wherein the component stored in host storage is a file stored on a hard drive of said host.

9. A software authentication system according to claim 1, further comprising a data storage device, wherein the communications channel between the first software element and the data storage device is authenticated with a technique including at least handshaking algorithms with a secure memory with authentication integrated circuit included in said data storage device.

10. A software authentication system according to claim 1, wherein the first software element is a driver software element.

11. A software authentication system according to claim 10, wherein the second software element is firmware included in a data storage device, such that the firmware included in the data storage device authenticates the driver software element.

12. A software authentication system according to claim 1, wherein the first software element is a content providing software application.

13. A software authentication system according to claim 12, wherein the second software element is a driver software element, such that the driver software element authenticates the content providing software application.

14. A software authentication system according to claim 1, wherein the second software element performs a handshaking algorithm with the first software element before proceeding to authenticate said first software element.

15. A software authentication system according to claim 1, further comprising a storage medium and a data storage device, wherein a communications channel between the data storage device and the storage medium is authenticated with a technique including at least one of a retroreflective marker, latent illuminance marker, disk indelible utility mark (DIUM), holographic marker included on said storage medium.

16. A software authentication system according to claim 1, wherein said hashed result is formed from said accessed component using at least one of few, division, multiplication, variable string addition, variable string exclusive-or and double variable string exclusive-or hash function algorithms.

17. A software authentication system according to claim 1, wherein said asymmetric encryption and decryption are performed using at least one of RSA, Diffie-Hellman, Elliptic-Curve and PGP asymmetric cryptography algorithms.

18. A software authentication system according to claim 1, wherein said correlation occurs when one from the following group occurs: (1) when said first and second digital signatures are identical, (2) when a portion of said first digital signature is identical to a portion of second digital signature, (3) when said first digital signature equals said second digital signature after applying a predetermined algorithm to one of said first and second digital signatures and (4) when said first digital signature maps to said second according to an interpreted off-set match.

19. A method for authentication of a first software element stored in the memory of a host computer by a second software element, comprising:
said second software element requesting authentication information from said first software element;
in response to said requesting of authentication information, transmitting a first encrypted digital signature from said host computer to said second software element, retrieving by said second software element a public key for use with said first encrypted digital signature, accessing at least one portion of a component stored in the host storage, hashing said at least one portion to form a second digital signature;
in response to receiving said transmitted encrypted first digital signature, decrypting said encrypted first digital signature by said second software element with the public key and comparing the decrypted first digital signature to the second digital signature that is accessible to said second software element; and
determining that said first software element is authenticated if said first digital signature correlates with said second digital signature.

20. A method for authenticating according to claim 19, wherein the first software element is a data storage device driver software element, wherein the second software element is a content providing software application, and wherein the method for authentication is a method for authentication of the data storage device driver software element by the content providing software application.

21. A method for authenticating according to claim 19, further including instantiating a third software element which performs said accessing of said at least one portion of a component stored in said host storage.

22. A method for authenticating according to claim 21, wherein said instantiating includes instantiating said third software element in memory space allocated for drivers in said host computing system, and wherein said first software element is a driver software element.

23. A method for authenticating according to claim 19, wherein the accessing and hashing of said at least one portion of the component stored in host storage includes accessing and hashing at least one portion of the first software element.

24. A method for authenticating according to claim 23, wherein the accessing of at least one portion of the first software element stored in host storage is performed during runtime of the first software element.

25. A method for authenticating according to claim 19, wherein the accessing and hashing of said at least one portion of the component stored in host storage includes the accessing and hashing of a file stored on a hard drive of said host.

26. A method for authenticating according to claim 19, further comprising authenticating a communications channel between the first software element and a data storage device with a method including at least handshaking algorithms with a secure memory with authentication integrated circuit included in said data storage device.

27. A method for authenticating according to claim 19, wherein the first software element stored in the host storage is a data storage device driver software element, wherein the second software element is a data storage device, and wherein the method for authentication is a method for authentication of the storage device driver software element by the data storage device.

28. A method for authenticating according to claim 19, further comprising authenticating the communications channel between a data storage device and a storage medium with a method including attaching at least one of a retroreflective marker, latent illuminance marker, disk indelible utility mark (DIUM), holographic marker to said storage medium.

29. A method for authenticating according to claim 19, wherein said hashing to form a hashed result from said accessed at least one portion of the component utilizes at least one of few, division, multiplication, variable string addition, variable string exclusive-or and double variable string exclusive-or hash function algorithms.

30. A method for authenticating according to claim 19, wherein said asymmetric encrypting and decrypting are performed using at least one of RSA, Diffie-Hellman, Elliptic-Curve and PGP asymmetric cryptography algorithms.

31. A method for authenticating according to claim 19, wherein said determining includes determining that said first software element is authenticated if one from the following group occurs: (1) if said first and second digital signatures are identical, (2) if a portion of said first digital signature is identical to a portion of second digital signature, (3) if said first digital signature equals said second digital signature after applying a predetermined algorithm to one of said first and second digital signatures and (4) if said first digital signature maps to said second according to an interpreted off-set match.

32. A computer-readable medium having computer-executable instructions for instructing a computer to perform the method recited in claim 19.

33. A modulated data signal carrying computer-executable instructions for performing the method as recited in claim 19.

34. A method for authentication of a device driver software element stored in the memory of a host computer by an application, comprising:
said application instantiating a proxy driver software element;
said proxy driver software element requesting authentication information from said device driver software element;
in response to said requesting of authentication information, transmitting a first encrypted digital signature from said host computer to said application, retrieving by said application a public key for use with said first encrypted digital signature, accessing by said proxy driver software element at least one portion of a component stored in the host storage, hashing said at least one portion to form a second digital signature;
in response to receiving said transmitted encrypted first digital signature, decrypting said encrypted first digital signature by said application with the public key and comparing the decrypted first digital signature to the second digital signature that is accessible to the application via said proxy driver software element; and
determining that said device driver software element is authenticated if said first digital signature correlates with said second digital signature.

35. A method for authenticating according to claim 34, wherein the accessing and hashing of said at least one portion of the component stored in host storage includes accessing and hashing at least one portion of the device driver software element.

36. A method for authenticating according to claim 35, wherein the accessing of at least one portion of the device driver software element stored in host storage is performed during runtime of the device driver software element.

37. A method for authenticating according to claim 34, wherein the accessing and hashing of said at least one portion of the component stored in host storage includes the accessing and hashing of a file stored on a hard drive of said host.

38. A method for authenticating according to claim 34, further comprising authenticating a communications channel between the device driver software element and a data storage device with a method including at least handshaking algorithms with a secure memory with authentication integrated circuit included in said data storage device.

39. A method for authenticating according to claim 34, further comprising authenticating the communications channel between a data storage device and a storage medium with a method including attaching at least one of a retroreflective marker, latent illuminance marker, disk indelible utility mark (DIUM), holographic marker to said storage medium.

40. A method for authenticating according to claim 34, wherein said hashing to form a hashed result from said accessed at least one portion of the component utilizes at least one of few, division, multiplication, variable string addition, variable string exclusive-or and double variable string exclusive-or hash function algorithms.

41. A method for authenticating according to claim 34, wherein said asymmetric encrypting and decrypting are performed using at least one of RSA, Diffie-Hellman, Elliptic-Curve and PGP asymmetric cryptography algorithms.

42. A method for authenticating according to claim 34, wherein said determining includes determining that said device driver software element is authenticated if one from the following group occurs: (1) if said first and second digital signatures are identical, (2) if a portion of said first digital signature is identical to a portion of second digital signature, (3) if said first digital signature equals said second digital signature after applying a predetermined algorithm to one of said first and second digital signatures and (4) if said first digital signature maps to said second according to an interpreted off-set match.

43. A computer-readable medium having computer-executable instructions for instructing a computer to perform the method recited in claim 34.

44. A modulated data signal carrying computer-executable instructions for performing the method as recited in claim 34.
